(19) United States
(12) Patent Application Publication
(10) Pub. No.: US 2016/0150018 A1
(43) Pub. Date: May 26, 2016

(54) Method and System for Storing and Providing Electronic Records of Individual Users

(71) Applicants: Eliahu Botier, Rego Park, NY (US); Arik Botier, Little Neck, NY (US)

(72) Inventors: Eliahu Botier, Rego Park, NY (US); Arik Botier, Little Neck, NY (US)

(21) Appl. No.: 14/952,790

(22) Filed: Nov. 25, 2015

Related U.S. Application Data
(60) Provisional application No. 62/085,123, filed on Nov. 26, 2014.

(51) Int. Cl. H04L 29/08; H04L 29/06

(52) U.S. Cl. CPC H04L 67/1097; H04L 67/42

(57) ABSTRACT

A method and system for electronically sharing user memories, the method comprising receiving user events data at a server, generating, via the server, user memory data from the user events data, and distributing the user memory data from the server to one or more user devices at given times based on a distribution configuration, the distribution configuration including one or more dates configured specifying distribution of the user memory data to users of the one or more user devices.

### RELATED APPLICATION

This application claims the benefit of U.S. (Provisional) Application No. 62/085,123, filed Nov. 26, 2014, which is incorporated herein.

### BACKGROUND OF THE INVENTION

1. Field of the Invention

The invention described herein generally relates to storing electronic data, and in particular, managing electronic records of individual users for distribution to select individuals upon certain dates.

2. Description of the Related Art

In our fast-paced and ever-changing world, we live our lives rarely thinking about leaving for our loved ones the story of our life as we lived it. While some people do write their memoirs, a majority of people resort to leaving behind short remarks in social media (e.g., Facebook®, Twitter®, MySpace®, etc.) or next to the pictures in photo albums that capture only a miniscule fraction of their life. As a result, only very few of us are fortunate to know the life stories of our predecessors.

Accordingly, there is a need in a method and system for recording, storing, and retrieving electronic records of individual users to preserve it and make it available for the benefit of the user's friends and family and to provide users with peace of mind that important personal information is accurately compiled, organized, and preserved for future generations.

### SUMMARY OF THE INVENTION

The present invention provides a method and system for electronically sharing user memories. The method comprises receiving user events data at a server, generating, via the server, user memory data from the user events data, and distributing the user memory data from the server to one or more user devices at given times based on a distribution configuration, the distribution configuration including one or more dates configured specifying distribution of the user memory data to users of the one or more user devices.

The user events data may include at least one of text, documents, images, and multimedia content. According to one embodiment, the method further comprises facilitating a logical connection between electronic records of individual users based on an identified connection between the individual users. A notice may also be presented to a user associated with the user memory data to include possible acquaintance to users of the one or more user devices to the distribution configuration based on the logical connection. In another embodiment, the method further comprises communicating the memory data to a graphical user interface of a device upon detecting a presence of a visitor in close proximity to a burial site of a user associated with the user memory data.

The system comprises a processor, and a memory having executable instructions stored thereon that when executed by the processor cause the processor to receive user events data; generate user memory data from the user events data; and distribute the user memory data to one or more user devices at given times based on a distribution configuration, the distribution configuration including one or more dates configured specifying distribution of the user memory data to users of the one or more user devices.

According to one embodiment, the processor facilitates a logical connection between electronic records of individual users based on an identified connection between the individual users. The processor may further present a notice to a user associated with the user memory data to include possible acquaintance to users of the one or more user devices to the distribution configuration based on the logical connection. In another embodiment, the processor communicates the memory data to a graphical user interface of a device upon detecting a presence of a visitor in close proximity to a burial site of a user associated with the user memory data.

The present invention also provides for non-transitory computer readable media comprising program code that when executed by a programmable processor causes execution of a method for electronically sharing user memories, the computer readable media comprising: computer program code for receiving user events data, computer program code for generating user memory data from the user events data, and computer program code for distributing the user memory data to one or more user devices at given times based on a distribution configuration, the distribution configuration including one or more dates configured specifying distribution of the user memory data to users of the one or more user devices.

In one embodiment, the computer readable media further comprises computer program code for facilitating a logical connection between electronic records of individual users based on an identified connection between the individual users. The computer readable media may further comprise computer program code for presenting a notice to a user associated with the user memory data to include possible acquaintance to users of the one or more user devices to the distribution configuration based on the logical connection. According to another embodiment, the computer readable media further comprises computer program code for communicating the memory data to a graphical user interface of a device upon detecting a presence of a visitor in close proximity to a burial site of a user associated with the user memory data.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a flowchart of a method for electronically sharing user memories according to an embodiment of the present invention; and

FIG. 2 illustrates a computing system according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The present invention includes a method and apparatus for recording and storing electronic records of individual users to preserve it and make it available for the benefit of the user's friends and family. According to one embodiment, the method and system allows permanent storage and easy retrieval of individual and family records and memories (detailed, chronological history and background of each period of one's life—complete with pictures, documents, school/college projects, awards, transcripts, completed personal information questionnaires, audio and video clips, and the like). The described method and system allows permanent and non-degradable storage (and retrieval) of family memories for the timeless preservation of family information without concerns of technology changes, natural or man-made disasters, degradation of existing media and memories, or relocating families. This, in turn, can be used for providing future family members facts about health, wealth, genealogical, cultural and family traditions, or other information which may be essential to know or understand about the past.

Embodiments of the present invention allow permanent storage and easy retrieval of individual and family records and memories (detailed, chronological history and background of each period of one's life—complete with pictures, documents, school/college projects, awards, transcripts, completed personal information questionnaires, audio and video clips, and the like). The present invention is also directed to provide a method and apparatus for recording electronic records about individual users provided by a third-party (friends, family, co-workers, comrades, etc.) for the benefit of the individual users. For example, friends and family members, who possess certain documents, pictures, audio/video files about the certain events stored by the user on the system, may supply such data to the system to be stored in the relevant format in addition to the stored data.

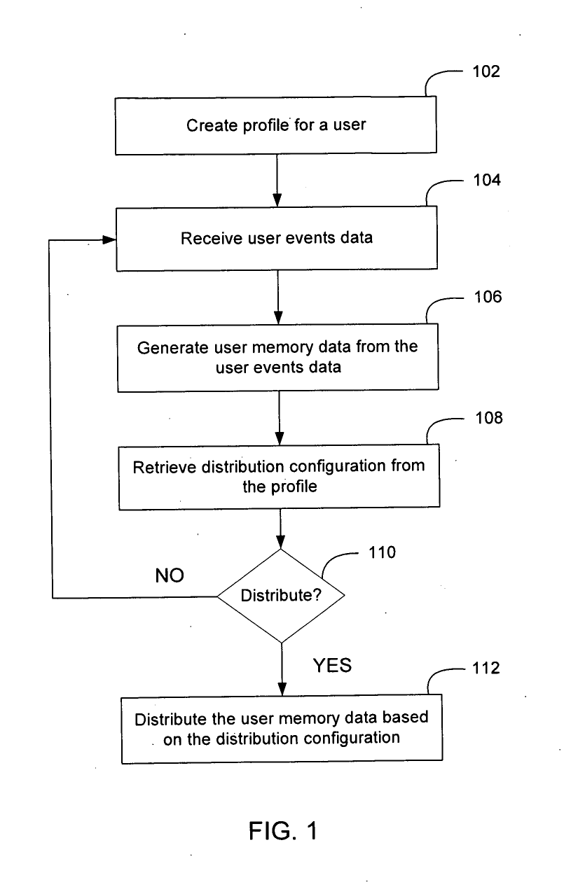

FIG. 1 presents a flowchart of a method for electronically sharing user memories according to an embodiment of the present invention. A computing server may be configured to provide users with accounts to store various content that may be shared with others on common or different platforms. A profile for a user is created, step 102. The profile may include information such as name, date of birth, email address, phone number, occupation, location of residency, personal contacts (or identification of users, individuals, organizations, entities, etc.), education information, affiliations or memberships, dates of significance, anniversaries, and distribution configuration. In one embodiment, the distribution configuration allows for users to distribute content associated with their accounts to certain personal contacts upon a given event, date, or trigger.

User events data are received, step 104. The user events data may include items associated with a user that may be electronically transmitted to and stored on the server. Events can include text, documents, images, and multimedia content. According to one embodiment, the user events data may be retrieved from social media/networking accounts associated with the user. The present invention is also directed to provide a method and apparatus for facilitating a logical connection between the electronic records of individual users based on an identified connection between the users. For example, the method and system is configured to identify a high probability that two users of the system may know each other or may have unknowingly participated in the same events. (Both users describe same particular event, such as participating in the same venture, using same or close dates, places, and participants). Upon identifying the high probability that two users of the system may know each other, the method and system may notify the user who stores data to allow the user to include the possible acquaintance to the list of people to whom the relevant part of the user's story may be sent on a certain date or trigger. The method and system may be configured to allow both users to exchange contact information and provide each other with additional details to be stored in effort to create a complete record of the described event.

User memory data is generated from the user events data, step 106. The user memory data may be the entirety or a portion of the events associated with the user. One or more embodiments of the present invention are directed to providing a method and apparatus for presenting the stored electronic records about the user. Distribution configuration from the profile is retrieved (step 108) to determine whether user memory data should be distributed, step 110. The user memory data is distributed based on the distribution configuration, step 112. User memory data may be transmitted on-demand or in accordance to the pre-determined triggers (birthdays, anniversaries, memorial days, holidays, and the like). Access to the memory data may be limited or restricted, according to the user's settings stored in the user profile, in the following exemplary ways: 1) Unlimited read-only access to anyone; 2) Release to immediate (identified) family members or friends identified in the user's profile; 3) Release to clergy; 4) Release to funeral home or cemetery officials.

Also, the method and system are configured to periodically send user memory data to certain individuals or groups identified in the user's profile based on dates or triggers identified by the system in the distribution configuration. For example, if the user is a veteran who identified some of his comrades in the events data as people who participated with the user in the D-Day in Normandy, France during WWII, the method and system is configured to send to the identified comrades a portion of the user's story about this event annually on Jun. 6 (anniversary of the D-Day). In another example, the method and system are configured to send a random portion of a user's stored events data to the user's identified family members or friends or the family member's or friend's birthdays or other important day identified by the user in the user profile or in the stored data itself.

In yet another example, the method and system are configured to retrieve and communicate memory data to a graphical user interface installed on or integrated in the headstone of the user upon detecting a presence of a visitor in the close proximity to the burial site of the user. Alternatively, the method and system are configured to retrieve and communicate memory data to an electronic mobile device of a visitor of the burial site of the user upon detecting the presence of the visitor in close proximity to the burial site. It is to be understood that the electronic mobile device of a visitor is configured (e.g., running an application download prior to visiting or at the burial site of the user) to receive the transmitted data of the user.

The present invention also includes method and apparatus configured to assemble the user's memory data into a printed publication (album, booklet, book, postcard, musical album, etc.) by the user or on-demand by the user's family and friends. Creation and sending of the printed publication or an electronic compilation of the stored memory data may be gratuitous or for a fee.

The present invention is also directed to provide a method and apparatus for electronically accepting and distributing funds donated for the benefit of the individual user's friends, families, charities, pledges, etc.

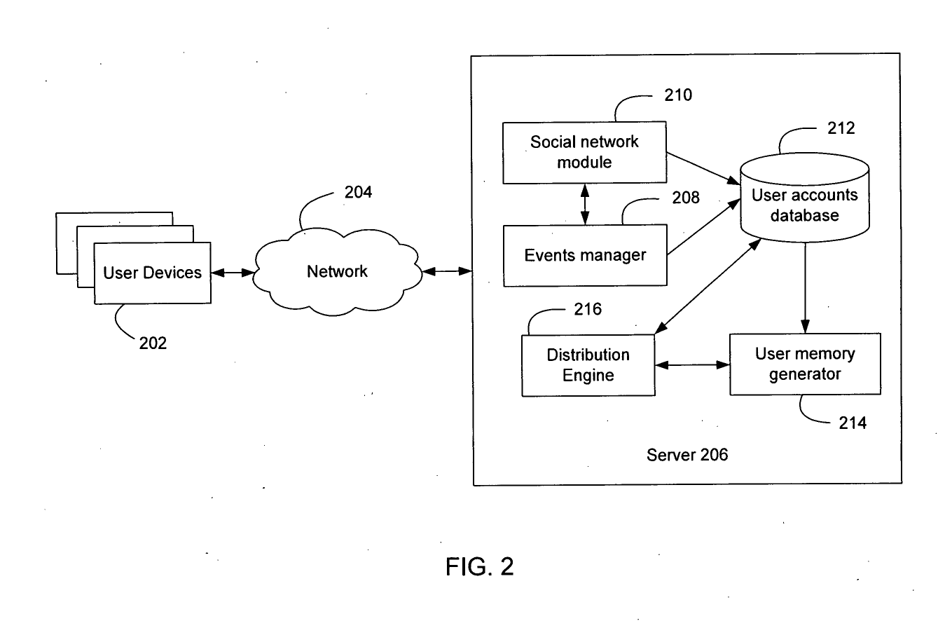

FIG. 2 presents a computing system according to an embodiment of the present invention. The present invention includes an apparatus which includes at least one processor and memory storing computer program instructions, which when executed on the processor, causes the processor to perform the steps of the described method. It is to be understood that the processor may be installed in or be in communication with at least one server device 206.

The at least one server device 206 is communicatively coupled with a plurality of user devices 202 over a communications network 204. The user devices 202 may be configured to communicate with the at least one server device 206 to receive and process the user data sent by the server device 206 in accordance with the settings in the user's profile stored in the memory. The plurality of user devices 202 may be any number of known electronic devices, including but not limited to hand-held electronic devices (cell-phones, tablets, PDA's, and the like), portable and stationary computing devices (desktops, laptops), electronic user interfaces having a wired and/or wireless transceiver, motion-sensing, and photo-sensing capabilities (LCD monitors installed at the burial site of the user). It is to be understood that the memory is capable of storing data in all known formats: documents (e.g. birth certificate, general documents, transcripts, medical records, drawings, diplomas, obituary statements, maps, etc.), audio (e.g. tapes, CDs, computer audio files etc.), video (e.g. tapes, film, computer video files, etc.), photographs (e.g. photos, slides, computer graphics files, etc.), data (e.g. input sheets, typed information, etc.), and other media types which may become available (e.g. holographic images).

Server 206 includes events manager 208, social network module 210, user accounts database 212, user memory generator 214, and distribution engine 216. Events manager 208 may manage the creation of events for storage in user accounts database 212 with user profiles. For example, events manager 208 may manage the workflow or steps for creating events. The events created by events manager 208 can be stored with the user profiles in user accounts database 212. Social network module 210 is configurable to retrieve information useful for creation of a user profile and events data from one or more social network/media servers. The social network module 210 may also retrieve information such as relationship data between individuals.

The social network module 210 is also configurable to conduct a search for and retrieval of personal and contact information of persons listed by, related to or affiliated with an individual who initiated entry and collection of personal and family data. For example, upon entry by an individual of his life memoirs that list names of said individual's family members, friends, co-workers, comrades, acquaintances, and the like, the social network module 210 initiates access to various social media outlets (e.g., Facebook®, LinkedIn®, Instagram®, Google, and the like), directories (e.g., white pages, people search, etc.), paid search directories (e.g., LexisNexis, Westlaw, Ancestry, etc.) to locate, cross-reference and reconcile personal data and contact information for all persons mentioned by said individual. Said personal data and contact information can include biographic data, current and past contact information (phone numbers, email addresses, Skype nicknames, and the like) to be used by the disclosed system and method to contact the mentioned people in accordance with the disclosed scheduling algorithm, at predetermined period of times (birthdays, special occasions, dated mentioned by the individual in his memoirs, etc.) or upon occurrence of certain events (detection of close proximity of a named person's electronic device to the tombstone of the individual who stored digital “memoirs” on the disclosed system, etc.).

User memory generator 214 may retrieve a portion of or an entirety of events data to create user moments data that can be distributed by distribution engine 216. Distribution engine 216 can be programmed to distribute the user moments data to specific one or more user devices 202 at specific times according to the distribution configuration of a user's profile.

The foregoing description of the preferred embodiment of the invention has been presented for purposes of illustration and description. It is not intended to be exhaustive or to limit the invention to the precise form disclosed. Many alternatives, modifications, and variations will be apparent to those skilled in the art in light of the above teaching. For instance, the present invention could be readily implemented for any entity, including businesses, buildings, pets; countries, parks, museum displays, or any other person or thing for which information is desired to be stored and displayed. Likewise, the invention is not limited to the death industry. For instance, the present invention could be used to maintain a running biography of event and achievements, documented in a variety of formats, for a living person or other entity. Accordingly, this invention is intended to embrace all alternatives, modifications, and variations that fall within the spirit and broad scope of the amended claims.

FIGS. 1 through 2 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e:g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for electronically sharing user memories, the method comprising:
receiving user events data at a server;
generating, via the server, user memory data from the user events data; and
distributing the user memory data from the server to one or more user devices at given times based on a distribution configuration, the distribution configuration including one or more dates configured specifying distribution of the user memory data to users of the one or more user devices.

2. The method of claim 1 wherein the user events data include at least one of text, documents, images, and multimedia content.

3. The method of claim 1 further comprising facilitating a logical connection between electronic records of individual users based on an identified connection between the individual users.

4. The method of claim 3 further comprising presenting a notice to a user associated with the user memory data to include possible acquaintance to users of the one or more user devices to the distribution configuration based on the logical connection.

5. The method of claim 1 further comprising communicating the memory data to a graphical user interface of a device upon detecting a presence of a visitor in close proximity to a burial site of a user associated with the user memory data.

6. A system for electronically sharing user memories, the system comprising:
a processor; and
a memory having executable instructions stored thereon that when executed by the processor cause the processor to:
receive user events data; generate user memory data from the user events data; and
distribute the user memory data to one or more user devices at given times based on a distribution configuration, the distribution configuration including one or more dates configured specifying distribution of the user memory data to users of the one or more user devices.

7. The system of claim 6 wherein the user events data include at least one of text, documents, images, and multimedia content.

8. The system of claim 6 further comprising the processor facilitating a logical connection between electronic records of individual users based on an identified connection between the individual users.

9. The system of claim 8 further comprising the processor presenting a notice to a user associated with the user memory data to include possible acquaintance to users of the one or more user devices to the distribution configuration based on the logical connection.

10. The system of claim 6 further comprising the processor communicating the memory data to a graphical user interface of a device upon detecting a presence of a visitor in close proximity to a burial site of a user associated with the user memory data.

11. Non-transitory computer readable media comprising program code that when executed by a programmable processor causes execution of a method for electronically sharing user memories, the computer readable media comprising:
computer program code for receiving user events data;
computer program code for generating user memory data from the user events data; and
computer program code for distributing the user memory data to one or more user devices at given times based on a distribution configuration, the distribution configuration including one or more dates configured specifying distribution of the user memory data to users of the one or more user devices.

12. The computer readable media of claim 11 wherein the user events data include at least one of text, documents, images, and multimedia content.

13. The computer readable media of claim 11 further comprising computer program code for facilitating a logical connection between electronic records of individual users based on an identified connection between the individual users.

14. The computer readable media of claim 13 further comprising computer program code for presenting a notice to a user associated with the user memory data to include possible acquaintance to users of the one or more user devices to the distribution configuration based on the logical connection.

15. The computer readable media of claim 11 further comprising computer program code for communicating the memory data to a graphical user interface of a device upon detecting a presence of a visitor in close proximity to a burial site of a user associated with the user memory data.
